(19) United States
(12) Patent Application Publication
(10) Pub. No.: US 2025/0197688 A1
(43) Pub. Date: Jun. 19, 2025

(54) ADHESIVE SHEET

(71) Applicant: TOYOTA JIDOSHA KABUSHIKI KAISHA, Toyota-shi Aichi-ken (JP)

(72) Inventor: Hiroaki TAKEUCHI, Susono-shi Shizuoka-ken (JP)

(73) Assignee: TOYOTA JIDOSHA KABUSHIKI KAISHA, Toyota-shi Aichi-ken (JP)

(21) Appl. No.: 18/975,126

(22) Filed: Dec. 10, 2024

(30) Foreign Application Priority Data
Dec. 13, 2023 (JP) 2023-209776

(51) Int. Cl. C09J 7/38

(52) U.S. Cl. CPC C09J 7/38; C09J 2203/33; C09J 2301/312

(57) ABSTRACT

An adhesive sheet capable of improving handling properties and improving adhesive strength, the adhesive sheet includes an adhesive layer; the adhesive layer has unevenness on at least one surface; and a relationship between the unevenness and a pressurizing force applied to the adhesive sheet required for adhesion to an adherend, satisfies a predetermined formula.

### CROSS-REFERENCE TO RELATED APPLICATIONS

This application is based upon and claims the benefit of priority of the prior Japanese Patent Application No. 2023-209776, filed on Dec. 13, 2023, the entire contents of which are incorporated herein by reference.

### TECHNICAL FIELD

The present disclosure relates to an adhesive sheet.

### BACKGROUND

Various studies have been proposed for fuel cells (FC) as disclosed in Patent Document 1.
Patent Document 1: Japanese Patent Application Laid-Open (JP-A) No. 2015-035312
Patent Document 2: JP-A No. H09-157612
Patent Document 3: JP-A No. 2009-155504

Patent Document 1 discloses a fuel cell in which a bonding layer composed of an adhesive or a pressure-sensitive adhesive is disposed around a membrane electrode gas diffusion layer assembly (MEGA) to bond separators together. In the case of an adhesive having high adhesive strength, it is difficult to handle the adhesive because of its stickiness. In the case of an adhesive having reduced stickiness and easy handleability, the adhesive strength is low.

### SUMMARY

The disclosure was achieved in light of the above circumstances. An object of the disclosure is to provide an adhesive sheet configured to improve handleability and adhesive strength.

That is, the present disclosure includes the following embodiments.

<1> An adhesive sheet for fuel cells,
wherein the adhesive sheet comprises an adhesive layer;
wherein the adhesive layer has unevenness on at least one surface; and
wherein a relationship between the unevenness and a pressurizing force applied to the adhesive sheet required for adhesion to an adherend, satisfies the following formula (1):

F0>σ0×S1 Formula (1):

where F0 is the pressurizing force; σ0 is a plastic stress of the adhesive layer; and S1 is a cross-sectional area of the unevenness at half a height of the unevenness of the adhesive layer.
<2> The adhesive sheet according to <1>,
wherein the adhesive layer is at least one selected from the group consisting of a thermosetting elastomer, a thermoplastic elastomer and a resin.
   <3> The adhesive sheet according to <1> or <2>,
wherein the adhesive sheet comprises a core layer and the adhesive layer on at least one surface of the core layer.
   <4> A method of pressurizing an adhesive sheet for fuel cells,
wherein, when the adhesive sheet defined by <1> and the adherend are caused to adhere to each other, they are pressurized by a pressurizing force satisfying the formula (1).

The adhesive sheet of the present disclosure can improve handling properties and can improve adhesive strength.

### BRIEF DESCRIPTION OF THE DRAWINGS

In the accompanying drawings,

FIG. 1 is a schematic view showing an example of the adhesive sheet of the present disclosure;

FIG. 2 is a graph illustrating an example of a relationship between a stroke and a stress;

FIG. 3A is a schematic view showing an example of the adhesive sheet pressurizing method of the present disclosure;

FIG. 3B is another schematic view showing an example of the adhesive sheet pressurizing method of the present disclosure;

FIG. 3C is another schematic view showing an example of the adhesive sheet pressurizing method of the present disclosure;

FIG. 4 is a schematic view showing another example of the adhesive sheet of the present disclosure; and

FIG. 5 is a schematic view showing another example of the adhesive sheet of the present disclosure.

### DETAILED DESCRIPTION

Hereinafter, the embodiments of the present disclosure will be described in detail. Matters that are required to implement the present disclosure (such as common an adhesive sheet structures and production processes not characterizing the present disclosure) other than those specifically referred to in the Specification, may be understood as design matters for a person skilled in the art based on conventional techniques in the art. The present disclosure can be implemented based on the contents disclosed in the present specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like. In the present disclosure, the fuel gas and the oxidizing gas are collectively referred to as a reaction gas or a gas.

Adhesion in the present disclosure means that an adherend of interest sticks with intermolecular forces without heating.

In the present disclosure, there is provided an adhesive sheet for fuel cells,
wherein the adhesive sheet comprises an adhesive layer;
wherein the adhesive layer has unevenness on at least one surface; and
wherein a relationship between the unevenness and a pressurizing force applied to the adhesive sheet required for adhesion to an adherend, satisfies the following formula (1):

$$F 0 > σ0 \times S 1 \qquad Formula ( 1 )$$

where F0 is the pressurizing force; σ0 is a plastic stress of the adhesive layer; and S1 is a cross-sectional area of the unevenness at half a height of the unevenness of the adhesive layer.

Soft adhesives have a strong adhesive strength, but they are difficult to handle because they tend to stick. On the other hand, a hard adhesive is difficult to stick, but is not elastically deformed, so that the adhesive strength is weak.

In particular, when the adhesive is a sealing member of a fuel cell, a pressure resistance exceeding a 100 kPa is required with respect to gases and coolant, and a strong adhesive force is required.

Soft adhesives tend to soften at higher temperatures. If the maximum operating temperature is one hundred and tens of degrees of the battery, then a leak is likely to occur because of the aggregation and destruction of the bulk, rather than the interface separation of the adhesive.

The present disclosure provides the adhesive sheet that is difficult to stick during handling such as installation and can exhibit a strong adhesive force when pressurized. In the present disclosure, by forming unevenness on the surface of the adhesive layer of the adhesive sheet, the adhesive sheet is less likely to stick when being handled. In addition, the adhesive sheet has high stress and is easily plastically deformed when pressurized. Further, when it is desired to obtain a high adhesive force, by applying a force which becomes a stress of plastic deformation, plastically deforming the adhesive sheet, even after the load is removed, intermolecular force acts, and a strong adhesive force is maintained. The adhesive sheet of the present disclosure is suitable for use in sealing together members of a fuel cell that needs to seal gas, water, and the like at a high temperature.

The adhesive sheet of the present disclosure includes an adhesive layer.

The adhesive layer has unevenness on at least one surface. The adhesive layer may have unevenness on at least one surface of the surface, and may have unevenness on both surfaces.

The relationship between the pressure applied to the adhesive sheet required for adhesion to the adherend and the unevenness satisfies the following formula (1).

$$F 0 > σ0 \times S 1 \qquad Formula ( 1 )$$

F0 is the pressing force, σ0 is a plastic stress of the adhesive layer and S1 is a cross-sectional area of the unevenness at half the height of the unevenness of the adhesive layer.

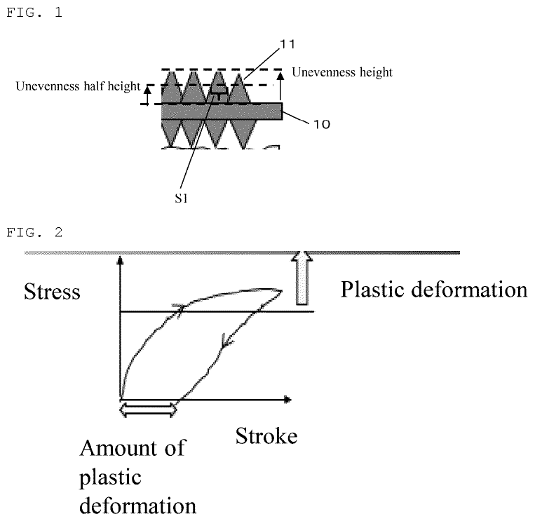

FIG. 1 is a schematic view showing an example of the adhesive sheet of the present disclosure.

As shown in FIG. 1, the adhesive sheet of the present disclosure may be a single sheet of the adhesive layer 10 having unevenness 11 on both surfaces thereof.

When the relation between the cross-sectional area S1 of the unevenness and the pressing force F0 at the height of half the height of the unevenness of the adhesive layer satisfies formula (1), the gap of the unevenness is filled by the plastic deformation of the adhesive sheet.

FIG. 2 is a graph illustrating an example of relationship between a stroke and a stress.

As shown in FIG. 2, the adhesive sheet can be plastically deformed by applying a pressure that becomes a stress of plastic deformation. The plastic stress σ0 of the present disclosure is a stress region where plasticity occurs, and means a region above the plastic deformation line of FIG. 2.

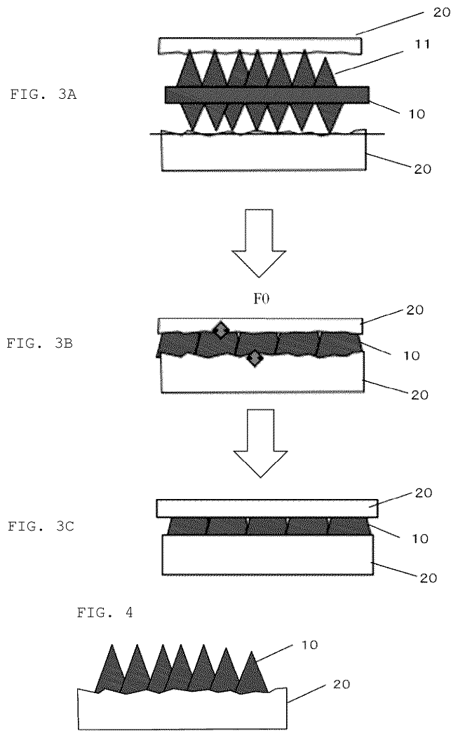

FIGS. 3A-3C are schematic views showing an example of the adhesive sheet pressurizing method of the present disclosure.

As shown in FIGS. 3A-3C, by attaching the unevenness 11 to the surface of the adhesive layer 10, as shown in FIG. 3A the ground contact surface is small in the normal state, less stickiness and good handling, as shown in FIG. 3B it becomes easy to plastic deformation by the load during pressurization, as shown in FIG. 3C after removing the load, the intermolecular force acts, the strong adhesive force is maintained.

In the present disclosure, when adhering the adhesive sheet to an adherend, the adhesive sheet and the adherend are pressed with a pressure that satisfies the formula (1). That is, the adhesive sheet and the adherend are adhered to claim other while the adhesive layer is plastically deformed by pressing the adhesive sheet under a F0 load so that the relation between the uneven shape of the adhesive layer and the pressing force satisfies the above formula (1). Accordingly, the handling property of the adhesive sheet can be improved, and the adhesive strength can be improved.

The pressurizing force F0 may be several kN or less from the viewpoint of downsizing and cost-reducing the manufacturing facility of the fuel cell.

The adhesive layer may be at least one selected from the group consisting of a thermosetting elastomer, a thermoplastic elastomer, and a resin. These materials can exhibit desired strength in the environment of water, acid, and the like during high-temperature operation of the fuel cell, start-up under freezing point of the fuel cell, and the like.

The thickness of the adhesive layer may be 5 μm or more, 30 μm or more, or 100 μm or less, or 40 μm or less, from the viewpoint of reducing the unit cell thickness, from the viewpoint of ensuring tackiness.

FIG. 4 is a schematic view showing another example of the adhesive sheet of the present disclosure.

As shown in FIG. 4, in the adhesive sheet of the present disclosure, the adhesive layer 10 may be disposed on one side of the one adherend 20, and the one adherend 20 and the other adherend 20 may be adhered by the adhesive layer 10.

The adhesive sheet may include a core layer and the adhesive layer on at least one surface of the core layer. The adhesive sheet may include the adhesive layer on both surfaces of the core layer.

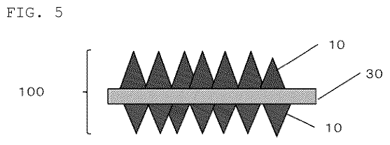

FIG. 5 is a schematic view showing another example of the adhesive sheet of the present disclosure.

As shown in FIG. 5, the adhesive sheet 100 of the present disclosure may be a three-layer sheet including a core layer 30 and the adhesive layer 10 on both surfaces of the core layer 30.

The core layer may be a structural member having a gas sealing property and an insulating property, and may be formed of a material whose structure does not change even under a temperature condition at the time of thermocompression bonding in the manufacturing process of the fuel cell. Specifically, the core-layer material may be, for example, a resin such as polyethylene, polypropylene (PP), PC (polycarbonate), PPS (polyphenylene sulfide), PET (polyethylene terephthalate), PEN (polyethylene naphthalate), PA (polyamide), PI (polyimide), PS (polystyrene), PPE (polyphenylene ether), PEEK (polyether ether ketone), cycloolefin, PES (polyether sulfone), PPSU (poly phenyl sulfone), LCP (liquid crystal polymer), and epoxy resin, or the like. The core-layer may be made of a rubber material such as EPDM (ethylene propylene diene rubber), fluorine-based rubber, and silicone-based rubber, or the like.

The thickness of the core layer may be 5 μm or more, 30 μm or more, or 100 μm or less, or 90 μm or less from the viewpoint of reducing the unit cell thickness, from the viewpoint of ensuring the insulating property.

The adhesive sheet may have a 10⁻⁵ Pa˜10⁻⁷ Pa elastic modulus at operating temperatures (e.g., −40° C. to 150° C.) of the fuel cell, since too hard the adhesive sheet may require a large amount of plastic deformation and a large amount of equipment.

Examples of the adherend may be a separator, a resin frame, an electrolyte membrane, a gas diffusion layer, and a catalyst layer, or the like.

The adhesive sheet of the present disclosure is for fuel cells.

The fuel cell may have only one unit cell (cell) of the fuel cell, or may be a fuel cell stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The unit cell may include a power generator.

The shape of the power generator may be a rectangular shape in a plan view.

The power generator may be a membrane electrode assembly (MEA) comprising an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalytic layer and may optionally include a gas diffusion layer, and the power generator may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas-diffusion layer (GDL) may comprise a substrate and a mesoporous layer (MPL).

GDL may include a base material on a side in contact with the separator and a MPL on a side in contact with the catalytic layer.

The base material may be a conductive member or the like having gas permeability.

Examples of the base material include a carbon porous body such as carbon cloth and carbon paper, and a metal porous body such as a metal mesh and a metal foam.

MPL may include a mixture of a water-repellent resin such as PTFE and a conductive material such as carbon black.

MPL may include an antioxidant such as Ce. The generation of radicals can be prevented by an antioxidant.

The unit cell may include a separator.

The separator collects current generated by power generation and functions as a partition wall. The separator is usually disposed on both sides of the power generation unit in the stacking direction such that a pair of separators sandwich the power generation unit in a unit cell. One of the pair of separators is an anode separator and the other is a cathode separator.

The anode separator may have a groove that serves as a fuel gas flow path on a surface on the side of the power generation unit.

The cathode separator may have a groove that serves as an oxidant gas flow path on a surface on the side of the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be the adhesive sheet of the present disclosure.

The fuel cell stack may include a gasket, a resin sheet, and the like for sealing each gas between the unit cells and the like. The resin sheet may be the adhesive sheet of the present disclosure.

### REFERENCE SIGNS LIST

10. Adhesive layer
11. Unevenness
20. Adherend
30. Core layer
100. Adhesive sheet

1. An adhesive sheet for fuel cells,
wherein the adhesive sheet comprises an adhesive layer;
wherein the adhesive layer has unevenness on at least one surface; and
wherein a relationship between the unevenness and a pressurizing force applied to the adhesive sheet required for adhesion to an adherend, satisfies the following formula (1):
$$F 0 > σ0 \times S 1 \qquad Formula ( 1 )$$
where F0 is the pressurizing force; σ0 is a plastic stress of the adhesive layer; and S1 is a cross-sectional area of the unevenness at half a height of the unevenness of the adhesive layer.

2. The adhesive sheet according to claim 1,
wherein the adhesive layer is at least one selected from the group consisting of a thermosetting elastomer, a thermoplastic elastomer and a resin.

3. The adhesive sheet according to claim 1,
wherein the adhesive sheet comprises a core layer and the adhesive layer on at least one surface of the core layer.

4. A method of pressurizing an adhesive sheet for fuel cells,
wherein, when the adhesive sheet defined by claim 1 and the adherend are caused to adhere to each other, they are pressurized by a pressurizing force satisfying the formula (1).
